(19) United States
(12) Patent Application Publication
(10) Pub. No.: US 2005/0201356 A1
(43) Pub. Date: Sep. 15, 2005

(54) Adaptive routing for hierarchical interconnection network

(76) Inventors: Yasuyuki Miura, Tokyo (JP); Susmu Horiguchi, Tokyo (JP)

Correspondence Address: BIRCH STEWART KOLASCH & BIRCH, PO BOX 747, FALLS CHURCH, VA, 22040-0747, US

(21) Appl. No.: 10/796,990

(22) Filed: Mar. 11, 2004

(51) Int. Cl. H04L 12/26

(52) U.S. Cl. 370/351

(57) ABSTRACT

In an adaptive routing for a hierarchical interconnection network using a mesh in a lower rank and a torus in a higher rank, an inter-basic-module link in the interconnection network is constituted by a ring-like link including 2^{m} nodes and a round-around channel; and a dynamic selection algorithm of a channel in the inter-basic-module link routes a packet such that, when virtual channels L and H in the same link in the upper rank, the head of the packet uses channel L at the start of a routing, the head of the packet moves to channel H immediately after the packet passes through an wrap-around channel; and, when the packet at channel L satisfies two conditions: (1) the wrap-around channel is not expected to be used in the middle of the routing; (2) a routing is expected to be ended when the packet passes through the wrap-around channel, the head of the packet can select channel H.

### BACKGROUND OF THE INVENTION

1. Field of the Invention

The present invention relates to a high-speed digital data processing system and, more particularly, to an adaptive routing which avoids deadlocks to make it possible to perform a high-speed processing.

2. Description of the Related Art

In recent years, demands for large-scale parallel processing in a large number of fields such as meteorological forecast, physical simulation, artificial intelligence, and image processing become high. Accordingly, a large number of parallel computers are developed. A three-dimensional IC technology for an industrial three-dimensional memory system has developed, and a three-dimensional computer is studied. For example, as described in Non-patent Document 1, Little and others develop a 32×32 size cellar array which is organized a 5-wafer stack.

[Non-patent Document 1] M. J Little, J. Grinberg, S. P. Laub, J. G. Nash, and M. W. Yung. The 3-D computer. IEEE Int'l Conf., Wafer Scale Integration, pp. 55-64, 1989.

This stack is constituted by wafers of two types, i.e., accumulators and shifters. The size of a die is 1 cubic inch, and a throughput at 10 MHz is about 600 MPOPS. Studies of nodes in a column direction are reported by Campbell in Non-patent Document 2 or Carson in Non-patent Document 3. In recent years, Kurino and the others proposes an advanced three-dimensional construction technology in Non-patent Document 4.

[Non-patent Document 2] Michael L. Campbell, Scott T. Toborg, and Scott L. Taylor. 3-D Wafer Stack Neurocomputing. IEEE Int'l conf., Wafer Scale Integration, pp. 67-74, 1993.

[Non-patent Document 3] J. Carson. The Emergence of Stacked 3D Silicon and Impacts on Microelectronics Systems Integration. IEEE Int'l Conf., Innovative Systems in Silicon, pp. 1-8, 1996.

[Non-patent Document 4]. H. Kurino, T. Matsumoto, K. H. Yu, N. Miyakawa, H. Tsukamoto, and M. Koyanagi. Three-dimensional Integration Technology for Real Time Micro-vision Systems. IEEE Int'l Conf., Innovative Systems in Silicon, pp. 203-212, 1997.

A serious obstacle to construction of a three-dimensional computer is an area cost for nodes in a column directions. Each node requires an area of 300 μm×300 μm. For this reason, miniaturization of nodes in a column direction is important in three-dimensional mounting. Hierarchical interconnection network TESH (Tori connected mESHes) and an H3D torus (Hierarchical 3-D torus) are disclosed in Non-patent Documents 5 and 6, respectively.

[Non-Patent Document 5]

V. K. Jain, T. Ghirnai, and S. Horiguchi. TESH: A New Hierarchical Interconnection Network for Massively Parallel Computing. IEICE Transactions, Vol. E80-D, No. 9, pp. 837-846, 1997.

[Non-Patent Document 6] S. Horiguchi. Wafer Scale Integration. In Proc. 6th International Microelectronics Conference, pp. 51-58, 1990.

TESH consists of two networks, i.e., a torus between a mesh serving as a basic module and a basic module (BM serving as a high-level network. In order to realize a multiprocessor system having a TESH network, a routing which is free from deadlocks caused by a virtual channel is very important.

However, a major part of a conventional routing algorithm is a critical algorithm. Even a routing which is free from deadlocks for inter-processor communication considers an ideal processor serving as a faultless processor which is free from an error in a multiprocessor system.

When any one of processors having a heavy load along a routing becomes heavy, a packet is delayed. When any one of the processors along the routing has an error, the packet cannot be transmitted. An adaptive routing improves both the performance and the fault tolerance of a interconnection network. With respect to a k-array n-cube type interconnection network, several adaptive routing algorithm (Non-patent Documents 7 to 9) which avoids a processor having an error and a fault to solve a hot-spot problem caused by a processor having a heavy load in dynamic communication are known (Non-patent Documents 7 to 9).

[Non-patent Document 7] C. S. Yang and Y. M. Tsai, “Adaptive Routing in k-array n-cube Multicomputers”, Proc. of ICPADS '96, pp. 404-411, 1996.

[Non-patent Document8] J. DUato “A New Theory of Deadlock-Free Adaptive Routing in Wormhole Networks”, IEEE Trans. on Parallel and Distributed Systems, Vol. 4, No. 12, pp. 1320-1331, 1993.

[Non-patent Document 9] W. J. Dally, “Deadlock-Free Adaptive Routing in Multicomputer Networks using Virtual Channels”, IEEE Trans on Parallel and Distributed Systems”, vol. 4, No. 4, pp. 466-474, 1993.

Although a deterministic routing algorithm for TESH is conventionally proposed, the deterministic routing has a problem in resistance to congestion or defect of a route on the way in the deterministic routing. For this reason, an adaptive routing algorithm must be discussed.

### SUMMARY OF THE INVENTION

The present invention provides an appropriate deadlock-free adaptive routing algorithm for a hierarchical network which increases an effective speed.

The first aspect of the present invention provides an adaptive routing for a hierarchical interconnection network using a mesh in a lower rank and a torus in a higher rank, wherein an inter-basic-module link in the interconnection network is constituted by a ring-like link including 2^{m} nodes and a round-around channel, and a dynamic selection algorithm of a channel in the inter-basic-module link routes a packet such that, when virtual channels L and H in the same link in the upper rank, a packet uses channel L at the start of a routing, the packet moves to channel H immediately after the packet passes through an wrap-around channel, and, when a packet at channel L satisfies two conditions: (1) the wrap-around channel is not expected to be used in the middle of the routing; (2) a routing is expected to be ended when the packet passes through the wrap-around channel, the packet can select channel H.

The second aspect of the invention provides an adaptive routing for a hierarchical interconnection network using a mesh in a lower rank and a torus in a higher rank, wherein an inter-basic-module link in the interconnection network is constituted by a ring-like link including 2^{m} nodes and a round-around channel, and an algorithm which selects a plurality of routes between the basic modules routes a packet such that, when two channels, i.e., channel 0 and channel 1 in rank-2, a packet uses channel 0 at the start of a routing, the packet moves to channel 1 in a round-trip, and, when a distance between a transmission source node and a destination node is 2^{m}/2, the packet selects an idle one of both channels in + direction and − direction, and otherwise, the destination node selects a near channel.

The third aspect of the invention provides an adaptive routing for a hierarchical interconnection network using a mesh in a lower rank and a torus in a higher rank, wherein an inter-basic-module link in the interconnection network is constituted by a ring network, and a dynamic selection algorithm of the inter-basic-module link defines a DR number which is the number of times of movement of a packet from a sub-phase 2.p to a sub-phase 2.q (q<p) the order of which is lower than that of sub-phase 2.p for each packet, records, when a packet acquires a channel, the DR number of the channel in the channel, and routes a packet such that, in the routing, an adaptive routing using a channel which is not used by a packet having a DR number which is not larger than the DR number of the self-packet is performed, and, when all the routings are blocked by packets having DR numbers which are not larger than the DR number of the self-packet, the packet moves to a deterministic routing channel without returning to the adaptive routing.

### BRIEF DESCRIPTION OF THE DRAWINGS

FIG. 1 is a diagram for explaining the concept of a worm-hole routing.

FIG. 2 is a diagram for explaining the concept of a deadlock.

FIG. 3 is a diagram for explaining the concept of a virtual channel.

FIG. 4 is a diagram showing the configuration of an example of a hierarchical interconnection network TESH according to the present invention.

FIG. 5 is a diagram for explaining an arrangement of an inter-BM link.

FIG. 6 is a routing algorithm for TESH according to the present invention.

FIG. 7 is a diagram for explaining transfer for TESH.

FIG. 8 is a diagram for explaining the maximum number of virtual channels for TESH according to the present invention.

FIG. 9 is a diagram for explaining an adaptive routing for TESH using a CS method according to the present invention.

FIG. 10 is a diagram for explaining an adaptive routing for TESH using an LS method according to the present invention.

FIG. 11 is a diagram for explaining an adaptive routing for TESH using a DDR method according to the present invention.

### DESCRIPTION OF THE PREFERRED EMBODIMENT(S)

Methods supposed to be best for the present invention will be described below on the basis of embodiments illustrated in the drawings.

Message Communication Scheme of Interconnection Network

A wormhole routing which is one of packet transfer schemes is a scheme having several advantages to another transfer scheme such as a store and forward scheme or a virtual-cut through scheme. In contrast to this, since blocking frequently occurs due to collation of packets, deadlocks of a connection network easily occurs. Various methods against the deadlocks are proposed. A method of adding a virtual channel to theoretically avoiding deadlocks are generally used to a wormhole routing.

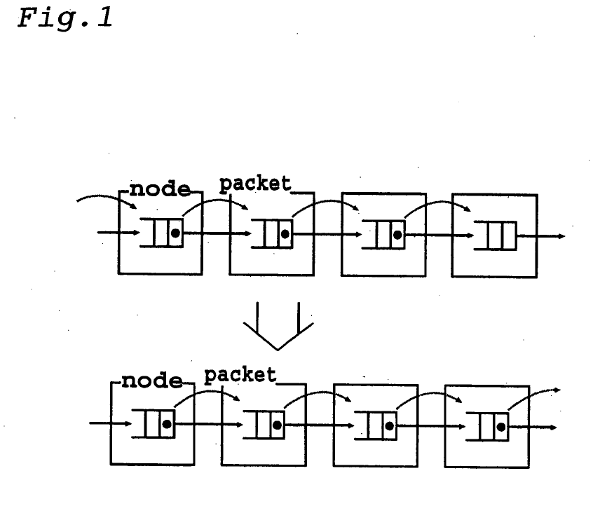

The wormhole routing is, as shown in FIG. 1, a method of dividing a packet into flits each serving as unit smaller than the packet to transfer the flits in a pipeline manner. This method is popularly used as a method for transferring a message on a parallel computer. The wormhole routing has the following features.
(1) Since a buffer for storing an entire packet is not necessary, the wormhole routing can be realized by a buffer size is smaller than that of a store and forward scheme or a virtual-cut through scheme. In face, the wormhole routing rarely has a buffer for holding an entire packet.
(2) When a packet length is large, a transfer rate is not easily dependent on a network distance.

With the above features, the wormhole routing is frequently used in place of a conventional store and forward scheme in message transmission of a parallel computer.

Deadlock

The wormhole routing is performed among a plurality of nodes, the number of times of collation of packets is larger than that in the store and forward scheme. For this reason, the frequency of occurrence of deadlocks disadvantageously increases. Therefore, a method of coping with deadlocks is required.

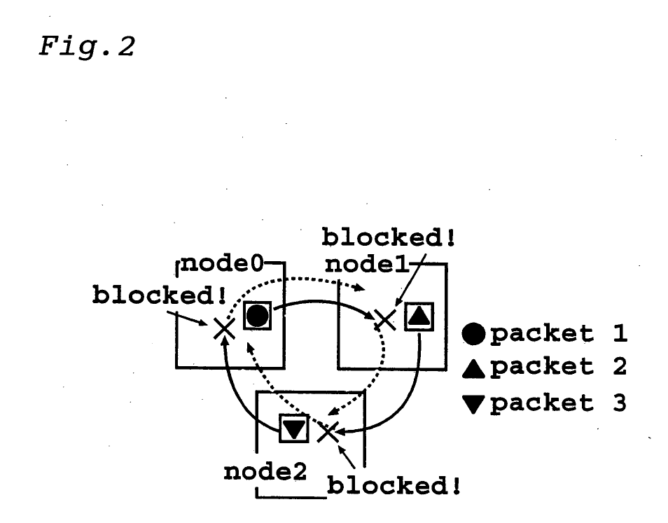

FIG. 2 is a conceptual diagram of a deadlock. As shown in FIG. 2, packet 1 moves from node 0 toward node 2 through node 1, and packet 2 moves from node 1 toward node 0 through node 2, and packet 3 moves from node 2 toward node 1 through node 0. At this time, when the three packets block progresses of the packets, the packets cannot move as a whole. Such a circular dependent state is called a deadlock.

The deadlock may occur in not only a wormhole routing but also any routing such as a store and forward method or a virtual-cut through method. In a wormhole routing, since packets frequently block the passages of the packets, the frequency of occurrence especially increases.

As methods of avoiding deadlocks, the following two roughly classified are known.
(1) A method of detecting a deadlock inside a connection network, removing a packet in which the deadlock occurs, and retransmitting the packet.
(2) A method of limiting the method of a routing or increasing the number of routes to theoretically avoid a deadlock.

In the former method of the above methods, the performance is deteriorated when the frequency of occurrence of deadlocks. For this reason, a system for performing wormhole routing, the latter method is mainly used.

Addition of Virtual Channel

When deadlocks are desired to be avoided without changing routes in a routing or when deadlocks cannot be avoided by changing routes, a method of arranging a plurality of transfer routes for each wire to handle each of the routes as an independent channel is effective. At this time, since a plurality of physical wires cannot be arranged without any problem in restrictions in hardware. Actually, one set of wires are shared by a plurality of virtual channels.

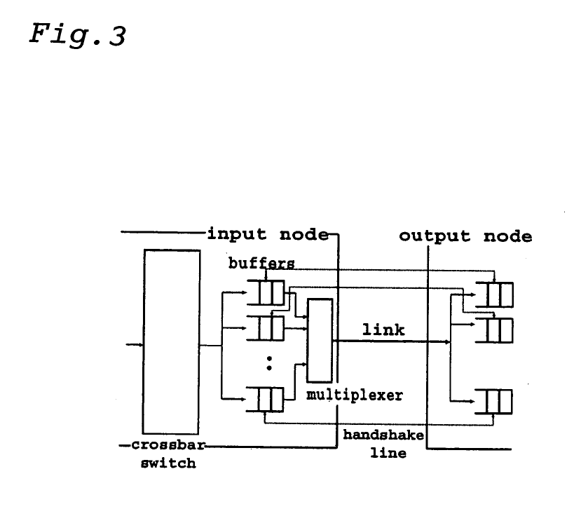

FIG. 3 is a conceptual diagram of a virtual channel. FIG. 3 shows an input node, an output node, and a link between both the nodes. Thick lines surrounding a cross bus switch, a buffer, or the like indicate the input node and the output node, respectively. As shown in FIG. 3, one link is shared by a plurality of buffers on the input/output sides. Of these buffers, a set of two buffers which share a handshake line and which are arranged across the input node and the output node are used as one virtual channel. The handshake line is used in adjustment between the input buffer and the output buffer.

In FIG. 3, a plurality of virtual channels are arranged. The plurality of virtual channels share one link in time-division manner. Adjustment between the plurality of virtual channels is performed by a multiplexer.

Deterministic Routing•Adaptive Routing

As routings on an interconnection network, a deterministic routing in which the same route is set from a start point to a destination point and an adaptive routing in which a plurality of routes can be selected from a start point to a destination point. The deterministic routing is often used in an actual parallel computer because the deterministic routing can be simply mounted. On the other hand, when the route on the way is congested or cannot be used due to defect, the route cannot be bypassed. With respect to this point, since the adaptive routing can select a plurality of routes, a route can be selected while avoiding congestion or defect. For this reason, in the adaptive routing, a throughput increases when the traffic of the network is congested. Furthermore, the adaptive routing advantageously operates without stopping the entire system when the route on the way is broken.

The hierarchical interconnection network TESH is a network which uses a mesh in a lower rank and a torus in a higher rank to utilize communication locality while having the features of both the connection networks. The number of wires between wafers is suppressed to a small number, and the communication locality is used, so that preferable network performance can be achieved. In order to mount a multiprocessor system by using TESH, a plurality of virtual channels must be added to avoid deadlocks. The number of virtual channels required at this time is dependent on the manner of arrangement inter-basic-module links, so that the links must be arranged by an appropriate method. The virtual channels must be selected by different methods depending on the methods of arrangement of the links.

In addition to a deterministic routing which is minimally required to avoid deadlocks, an adaptive routing which can select a plurality of routes is performed, the performance of the network can also be improved.

Dally and others proposed a simple and practical bypass routing obtained by using virtual channels and applied the bypass routing to k-array n-cube. In this method, the routing has r virtual channels, and an e-Cube routing, more specifically, a routing which determines an order of dimensions to transfer packets in advance is basically performed. When a packet is transferred by using a channel mame, if a channel in a direction of dimension to transfer a packet in the next place is not idle, a packet can be transmitted in an arbitrary direction of dimension independently of an order of an e-Cube routing in a Dimension reversal routing. However, the order of dimensions is reversed, the packet must be transferred to i+1 channel.

With this method, each time transfer independent of the order of dimensions, the channel number gradually increases. When the channel number reaches r−1, the adaptive routing cannot be performed any more, and a deterministic routing is performed in the order of dimensions according to the e-Cube routing. This method is called a static Dimension reversal routing.

In the static Dimension reversal routing, the channel number increases when the order of dimensions is reversed, the number of times of routing in the reversed direction of dimension is limited. In contrast to this, a dynamic Dimension reversal routing separately has a plurality of channels for adaptive routing and a plurality of channels for deterministic routing. The channels for deterministic routing can perform a deterministic routing according to the e-Cube routing, and the channels for adaptive routing can transmit packets in any direction of dimension. However, when a currently used channel number is i, and when all destinations 0 to i are busy, the routing cannot have these channels. For this reason, the routing must a channel having a channel number which is larger than i+1 (can have a channel which is larger than i+1). When the maximum number of the channels for adaptive routing is used, all the other channels for adaptive routing are busy, a packet is transmitted to the channels for deterministic routing, and the deterministic routing is subsequently performed. In this manner, the dynamic Dimension reversal routing can fortunately reverse the dimensions any number of times.

In contrast to this, an adaptive routing for TESH includes transitional routings in basic modules (BM) in units of dimensions of upper-level transfer. For this reason, the method which has been proposed by Dally and others cannot be directly applied as a global adaptive routing using an entire upper-level network.

For this reason, conditions under which a global adaptive routing can be applied must be exactly examined, and an adaptive routing which can be realized under the most efficient conditions must be discussed.

TESH Network

At the lowermost level of TESH, Level-1, the hierarchical network consists of PEs (Processing Elements) connected by a mesh network. The network is called a Basic Module (BM), and links in a BM are called intra-BM links. A BM consists of 2^{m}×2^{m} size mesh where m is a positive integer. Furthermore, higher level networks are recursively built to interconnect 2^{m}×2^{m} size next lower-level subnetworks in a 2D torus. A link constituted by high-level networks is called an inter-BM link.

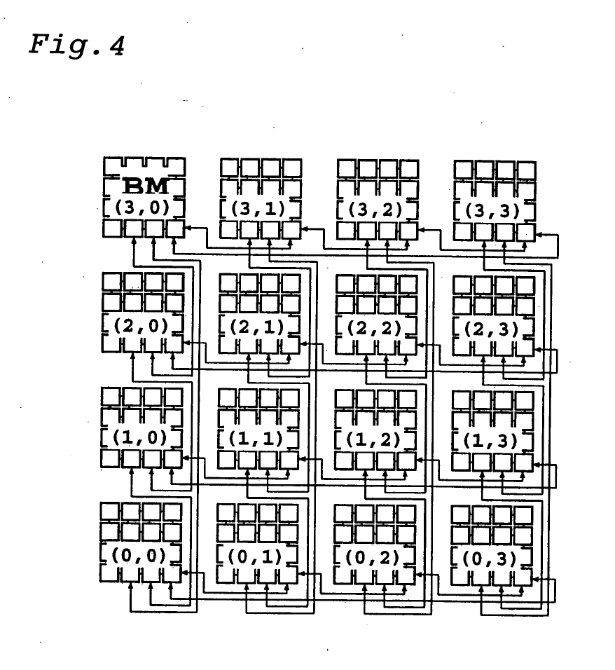

FIG. 4 shows an example of a hierarchical interconnection network TESH. In FIG. 4, four high-level links are used to connect 256 PEs. Furthermore, the four links are used to connect 2-level TESHs and construct a 3-level TESH.

Use of multiple links at each level makes it possible to connect the BMs. If 2^{q} inter-BM links are used for a level, the maximum of levels of a network becomes L=2^{m-q}+1. Use of parameters m, L, and q makes it possible to define various TESH. Therefore, the TESH are expressed by TESH (m, L, q). The number of PEs for TESH (m, L, q) is given by N=2^{2mL}.

The PEs in TESH (m, L, q) are addressed by using a base 2^{m} number as follows.
n=n_{2L-1}n_{2L-2} . . . n₁n₀=(n_{2L-1}n_{2L-2}) . . . (n₁n₀) [Equation 1]

In Equation 1, (n₂ᵢ₋₁n₂ᵢ₋₂) is the location of a subnetwork at level (i-1). In FIG. 4, PEs numbers are BM addresses (n₃, n₂) in the 2-level network which is addressed as previous.

According to interconnection of BMs, including PEn¹=(n¹_{2L-1}n¹_{2L-2} . . . n¹₁n¹₀) and PEn²=(n²_{2L-1}n²_{2L-2} . . . n²₁n²₀) are connected to each other. The n¹ and n² satisfy the following condition:
∃i{n¹₁=(n²_{i±1}) mod2^{m}\hat{ }∀j(j≠i→n¹ⱼ=n²ⱼ)}, (i, j≧2)
Link Allocation The free links around BMs are used for high-level interconnection. In this embodiment, it is assumed that BM (m=2), a 4×4 size mesh will be discussed. In order to make a routing algorithm more simple by reducing the network diameter of TESH, two links at corner PEs on BMs (n₁={0, 3} and n₀={0, 3}) are used for a pair of links for the same level and direction.

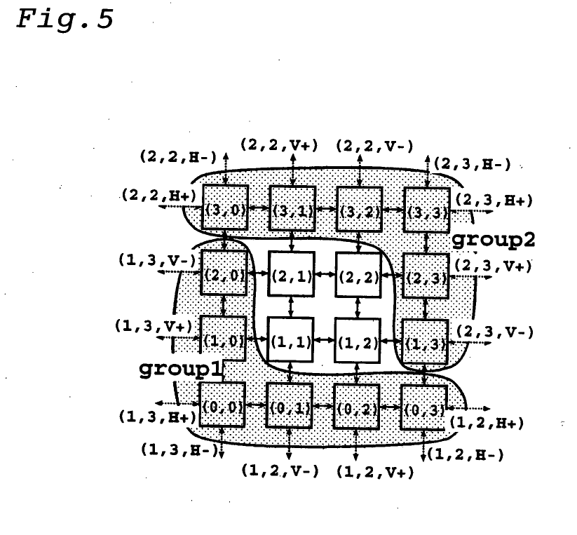

As shown in FIG. 5, the same direction links are arranged in-a-line from a high-level to a low level to reduce the number of hops. In this case, an in-a-line arrangement is defined as follows.
(1) The free links of a BM are classified into g=2^{q} groups, and each group has 4×(L−1) links.
(2) Each link is labeled as (g, l, dδ) by using level l (2≦l≧L), dimension d (dε{V, H}, and direction δ (δε{+, −})
(3) Links (g, 2, H+) and (g, 2, H−) of group g are arranged at PEs at both the corners of a BM.
(4) The link are arranged clockwise by the following order; (g, l, H+/−), (g, l, V+), (g, l, V−), and (g, l+1, H+/−).
(5) BMs are connected by links (g, l, d+) and (g, l, d−).
(6) If q≧1, links of different groups are symmetrically arranged by the center of BM.

In the above definitions, the direction + is the direction where the PE number is increasing and the direction − is the direction where the PE number is decreasing. The dimensions (V, H) indicate a vertical and horizontal links, respectively.

FIG. 5 shows an inter-BM link at level 3 of TESH (2, 2, 0). The in-a-line arrangement can reduce the number of hops between a high-level network and a low-level network. Furthermore, if q≧1, packets do not pass through central PEs (1, 1), (1, 2), (2, 1), and (2, 2), and routing directions are limited to specific directions. Thus, the number of virtual channels can be reduced.

Deadlock Free Routing

Packets are forwarded from a high level to a low level repeatedly. Packets passing through an inter-BM link are forwarded from a vertical link to a horizontal link at the same level as that of the vertical link. When the packets arrive at a destination BM, these packets are transferred to the destination. Intra-BM transfer has two directions, i.e., x direction and y direction. Each direction has + direction and − direction. Thus, the four directions x+, x−, y+ and y− are defined here.

In the case of q≧1, there are multiple links for the same level and direction. In this case, each node selects the nearest link. For example, to transfer one packet from a node (2, 1) to a vertical link at Level-2 in one BM, the packet is forwarded to node (2, 0) since the link at the node (2, 0) is nearest among the nodes with the same level link.

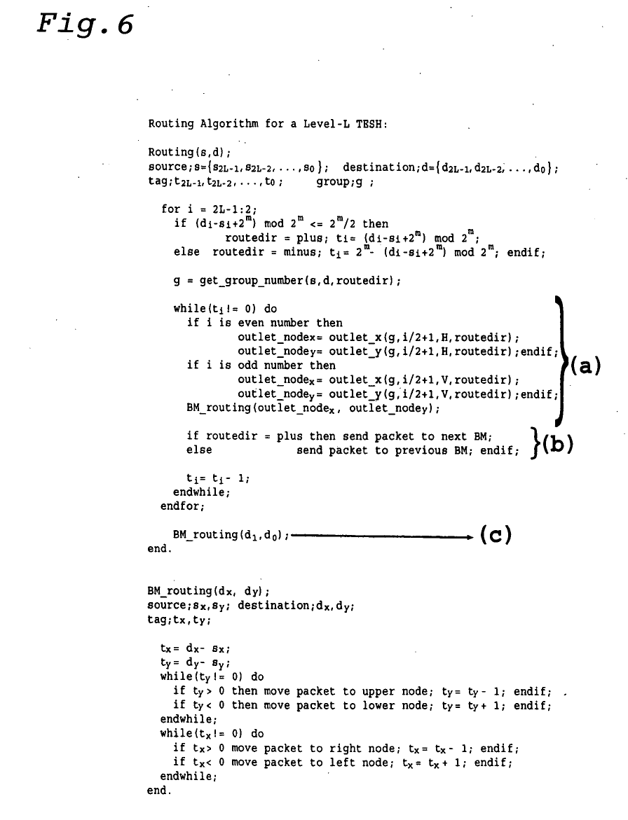

In this case, a routing algorithm for TESH at level L will be described below. In the TESH, source nodes s and destination nodes d are defined as s_{2L-1}s_{2L-2} . . . s₁s₀ and d_{2L-1}D_{2L-2} . . . d₁d₀, respectively. FIG. 6 shows the routing algorithm for TESH.

In FIG. 6, the function get_group_number gets a group number. The arguments of the function are s, d, and a routing direction.

Functions outlet_x and outlet_y m get an x-coordinate n₁ and a y-coordinate n₀ of a PEn having links (g, l, dδ). Variable g, l, and dδ are arguments of the functions outlet_x and outlet_y.

In order to obtain the link arrangement in FIG. 5, inter-BM transfer from a source node to a high-level link is executed by the routing algorithm. By using all the links in the BMs, inter-BM transfer from high-level links to destination nodes is executed.

Other inter-BM transfers are executed by using only links at peripheral nodes. Thus, two cases are separately considered to allocate virtual channels in TESH.

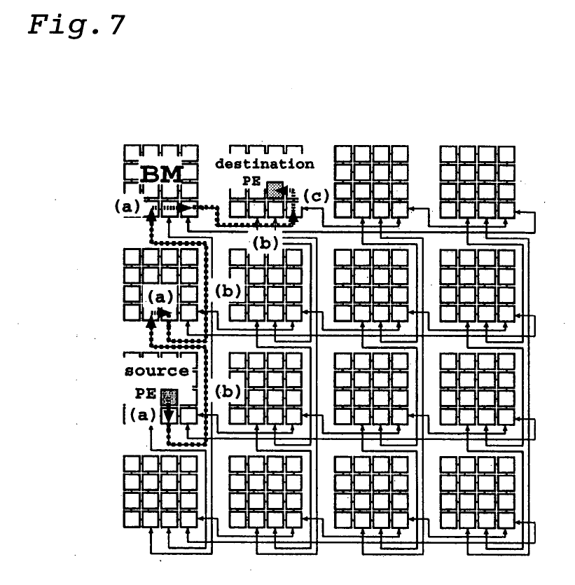

FIG. 7 shows an example of a deterministic routing. Since a channel number increases while transmitting a message, it is understood that the deterministic routing is free from deadlocks.

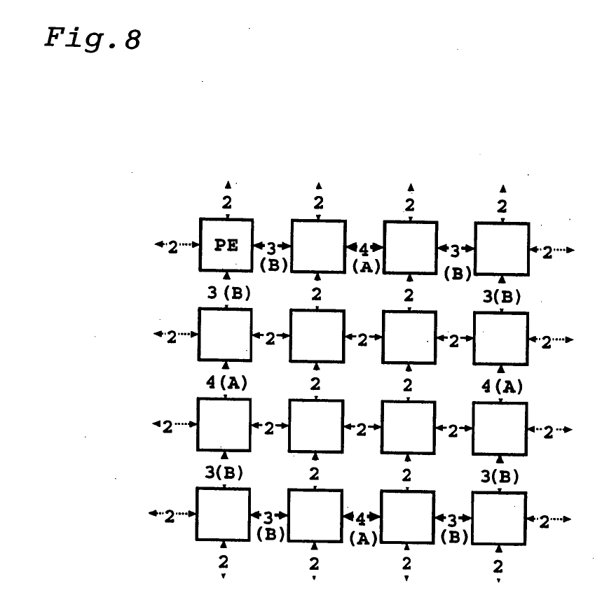

FIG. 8 shows the number of virtual channels required for TESH (2, 3, 1). In this case, in the illustrated link (A), a channel in rank-1, a channel in rank-3, and two channels in rank-2 are used. On the other hand, channels in rank-1, rank-3, and rank-2 are used in the illustrated link (B).

Rank

Intra-BM transfer (a in FIG. 6) toward a target inter-BM link is divided into the first iteration and the other. In addition, the final intra-BM transfer (c in FIG. 6) until a receiving PE after packets arrive at a target BM will be separately considered. In this case, the intra-BM transfer can be separated into the following three ranks.
Rank-1 Intra-BM transfer (the first iteration indicated by a in FIG. 6) performed until packets from a source PE arrive at the inter-BM link
Rank-2 Intra-BM transfer (remains of a in FIG. 6 and b) performed until packets arrive at a BM in which a receiving PE exist
Rank-3 Intra-BM transfer (c in FIG. 6) performed until a receiving PE after packets arrive at a target BM In this case, the transfer of packets is performed in the following order; (Rank-1), (Rank-2), and (Rank-3). Since Rank-2 has the shape of a torus, at least two channels are required. Since Rank-1 and Rank-3 have mesh-like shapes, each of Rank-1 and Rank-3 may use only one channel.

Therefore, channel 0 is allocated as a transfer channel of Rank-1, channels 1 and 2_ are allocated as transfer channels o Rank 2, and channel 3 is allocated as a transfer channel of Rank 3.

Phase•Sub-phase

In general, a routing for TESH at level L can be divided into the following three phases.
Phase-1 Intra-BM transfer until packets from a source PE arrives at PEs at four corners (n1=0 or 3 or n0=0 or 3 is satisfied) of a BM
Phase-2 Transfer at level j (2≦j≦L)
Phase-3 Intra-BM transfer from the outlet of an inter-BM link to a receiving PE

When packets arrive at the four corners of the BM by the first hop of transfer, Phase-1 is neglected. Phase-2 can be divided into the following sub-phases.
Sub-phase-2,i,1 Intra-BM transfer until packets arrive at the inlet PE of an inter-BM link in a column direction at level L-i
Sub-phase-2,i,2 Intra-BM transfer using an inter-BM link in a column direction at level L-i
Sub-phase-2,i,3 Intra-BM transfer until packets arrive at an inlet PE of an inter-BM link in a row direction at level i after transfer in the column direction at level L-i is finished
Sub-phase-2,i,4 Intra-BM transfer using an inter-BM link in the row direction at level L-i
   Adaptive Routing

First, the adaptive routing of k-array n-cube is applied to BMs and inter-BMs of TESH locally. Two different methods are proposed for hierarchical networks locally by choosing virtual channels or links of PEs. To explain the local adaptive routing, the local address of PEs, n_{local} is defined as follows,
n_{local=n}₂ₗ₋₁, Level-l column Link
n₂ₗ₋₂, Level-l row Link
   where n₂ₗ₋₁ and n₂ₗ₋₂ are defined in equation 1. Two local adaptive methods; channel and link selections will be defined using the local address of PEs, n_{local}.
   Channel Selection (CS)

TESH network adopts a tours network as inter-BMs. Since the tours network requires two virtual channels for each direction, the adaptive routing selects one of two vertical channels dynamically. The number of virtual channel is assigned as follows,
(ch, nᵢ), +direction channel,
(ch,4-nᵢ), −direction channel,
   where ch=(used virtual channel) and (0: channel L, 1: channel H).

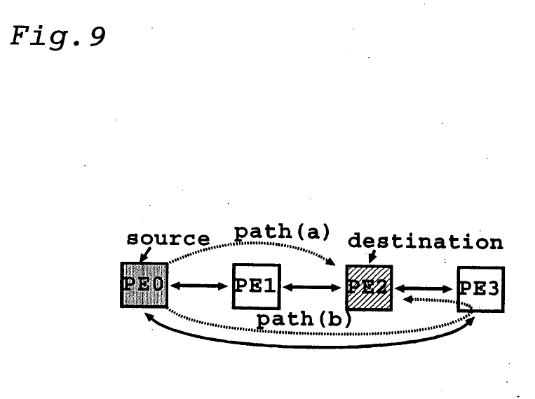

Then deadlock-free is proved for the bi-directional tours network, since the channel number is increased as message kept forwarding. FIG. 9 shows the adaptive routing of the tours with four PEs.

The routing does not use the wrap-round channel along the above adoptive routing form PE (n_{local}=0) to PE (n_{local}=2). In the case of routing without the wrap-round channel, the channel L is only used. Thus, the adaptive routing can use the channel H at the starting point, since the channel is not change in this case. In the case of routing with the wrap-round channel, since the routing from PE (n_{local}=2) to PE (n_{local}=0) is terminated at the wrap-round, the channel L is only used. Thus, the adaptive routing can also use the channel H at the starting point, since the channel is not change in this case too.

Also in the case using the wrap-round channel, as in a routing or the like from PE (2) to PE (0), only channel _ is also used when the routing is ended when packets pass through the wrap-round channel. For this reason, when packets moves to channel H on the way, or when channel H is used from the beginning, the channel numbers are arranged in ascending order.

In a deterministic routing in 4-PE ring network, only channel L is used when any one of the following conditions is satisfied.
When the wrap-round channel is not used in the middle of the routing.
When the routing is ended when packets pass through the wrap-round channel.

Under the following conditions, virtual channel numbers are arranged in ascending order along a routing route when any one of the following conditions.
When only channel L is used.
When only channel H is used.
Packets are moved from channel L to channel H in the middle of the routing.

The CS according to the present invention is an algorithm for effectively using channels the above conditions. In the algorithm of the CS, a routing is performed on the basis of the following three conditions.
Condition 1 Channel L is used at the start of the routing.
Condition 2 Packets move to channel H immediately after the packets pass through the wrap-round channel.
Condition 3 Packets can select channel H when packets located at channel L satisfy the following conditions.
(Condition 3-1) Wrap-round channel is not expected to be used in the middle of the routing.
(Condition 3-2) The routing is expected to be end when packets pass through the wrap-round channel.

The present inventors proved that the CS is deadlock-free.

Link Selection (LS)

Another way to apply an adaptive routing of k-array n-cube is a link selection (LS). The inter-BMs are interconnected in the form of a ring with 2m (four in this embodiment) PEs. For this reason, PEs with 2^{m}/2 pops can communicate with each other in the same distance if they use + link or − link.

Therefore, in the adaptive routing according to the second embodiment of the present invention adapts both the link selection of + link or − link.

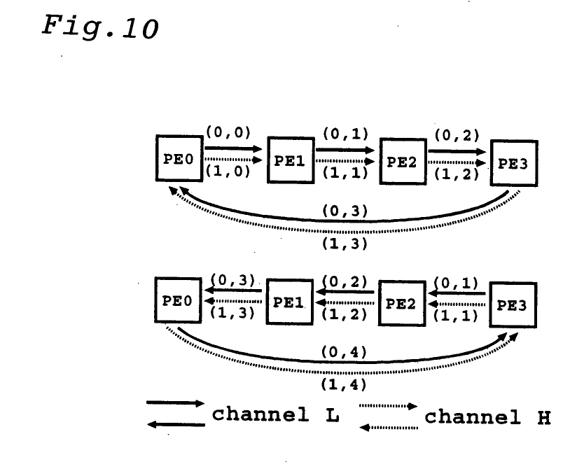

As shown in FIG. 10, for a routing from PE (n_{local}=0) to PE (n_{local}=2) of the ring interconnection with four PEs, the routing (a) or (b) can be chosen if the condition is satisfied as |s−d|=2, where s and d are the address of a source PE and the address of a destination PE.

A routing in an arbitrary BM is processed such that the following conditions are satisfied.
Condition 1 Channel 0 is used at the start of the routing.
Condition 2 Packets move channel 1 in a round-trip.
Condition 3 When a distance between the source PE and the destination PE is 2^{m}/2, an idle one of both the channels in + direction and − direction is selected, otherwise, the destination PE selects a near channel.

The present inventors proved that the LS is deadlock-free.

Global Adaptive Routing (DDR)

As described above, the deterministic routing of TESH starts from the upper-level to the lower level and from column direction to row direction in an inter-BM link. In a general routing of k-array n-cube, the order of dimensions of links to be used is determined. However, when an inverse order routing which performs a routing in the reverse order of the predetermined order of dimensions, the order of links to be used can be reversed.

In the DDR method according to the present invention, each packet has a value called a DR (Dimension Reversal) number. The DR number is defined as the number of transients from the sub-phase 2.p to the lower order sub-phase 2.q, (q<p). Since p and q are defined by p1.p0 or q1.q0, the orders are compared with each other on the assumption that p1.q1 and p0.q0 are regarded as an upper figure and a lower figure. The DR numbers are allocated as follows.
1. The DR numbers of all packets are set 0 initially.
2. When the packet moves from channel Cᵢ of sub-phase 2.p to channel cⱼ of the lower sub-phase 2.q, (q<p), the DR number of the packet is incremented.

In the DDR method according to the present invention, all channels are classified into an adaptive routing channel and a deterministic routing channel. First, each packet chooses the adaptive channel to perform the adaptive routing. When the packet has a channel, the DR number of the channel is recorded on the channel. To avoid the deadlock, the packet with DR number p cannot wait when the deterministic channel when all channels with DR number q (p≧q) are occupied.

All output channels of a given packet are occupied by packets having values smaller than that of the given packet, the packet moves to a deterministic channel. All the routes are blocked by packets having DR numbers which are equal to or smaller than that of the given packet, the packet moves to a deterministic routing channel. In the deterministic routing channel, a deterministic routing is performed. In the deterministic routing channel, a deterministic routing is performed, and, subsequently, the adaptive routing is not performed again.

The flow of the adaptive routing at an adaptive channel is as follows. In a DDR routing of k-array n-cube, a packet can select all dimensions in an adaptive routing channel. Since TESH is a hierarchical interconnection network, links constituting k-array and n-cube at an upper level are scattered at different positions in the same BM. For this reason, unlike k-array n-cube, a route for packets cannot be freely selected from a large number of inter-BM links.

However, in the middle of intra-BM transfer by a deterministic routing, a packet passes through PEs including inter-BM links several times. For this reason, the intra-BM transfer can be interrupted, and an inter-BM transfer by inter-BM links can be performed.

In the inter-BM routing, when a packet passes through these PEs, the following two routes can be selected.
Route 1 The intra-BM transfer is stopped to select an inter-BM link.
Route 2 The intra-BM transfer is continued.

When the above conditions are satisfied, Route 1 is preferentially selected. When Route 2 is selected, a dimensional reversal which breaks an original order of dimensions occurs.

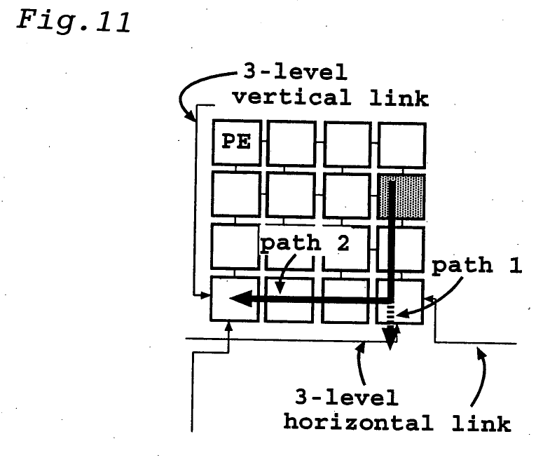

FIG. 11 shows an example of an adaptive routing for TESH using a DDR. In FIG. 11, a hatched PE indicates a source PE, a thick solid arrow in a BM indicates a route for a packet when a deterministic routing is performed.

In this example, it is assumed that a packet passes through a link (1, 3, V+/−) and a link (1, 3, H+/−) in the middle of transfer. In the deterministic routing, in Phase 1, the packet is sent to the inlet of the link (1, 3, V+/−). However, in the example in FIG. 11, the packet passes through a PE having a link (1, 3, H+/−) in the way. For this reason, it is checked whether the link (1, 3, H+/−) is available without being occupied by another packet or not.

If the link is available, the packet is transferred to the link (1, 3, H+/−) before the packet transferred to the link (1, 3, V+/−). If the link is not available, Route 2 is selected, and an intra-BM routing is continued.

Therefore, in a transfer in Phase 1, in addition to a routing along a route indicated by a thick solid line in FIG. 11, a routing along a route indicated by a thick dotted line can be performed.

As described above, three adaptive routing algorithms for a TESH network are proposed. It is proved that these adaptive routing algorithms are deadlock-free. In these algorithms, the performance of dynamic communication is evaluated by simulation. It is apparent that the proposed adaptive routing algorithms considerably improve the throughput of the TESH network. In addition, in case of hot-spot problem, dynamic communication performance can be improved by the adaptive routing. Even though the TESH network includes a defective or erroneous node, and a packet arrival rate increases.

1. An adaptive routing for a hierarchical interconnection network using a mesh in a lower rank and a torus in a higher rank, wherein
an inter-basic-module link in the interconnection network is constituted by a ring-like link including 2^{m} nodes and a round-around channel, and a dynamic selection algorithm of a channel in the inter-basic-module link routes a packet such that,
when virtual channels L and H in the same link in the upper rank,
a packet uses channel L at the start of a routing, the packet moves to channel H immediately after the packet passes through an wrap-around channel, and,
when a packet at channel L satisfies two conditions: (1) the wrap-around channel is not expected to be used in the middle of the routing; (2) a routing is expected to be ended when the packet passes through the wrap-around channel, the packet can select channel H.

2. An adaptive routing for a hierarchical interconnection network using a mesh in a lower rank and a torus in a higher rank, wherein
an inter-basic-module link in the interconnection network is constituted by a ring-like link including 2^{m} nodes and a round-around channel, and an algorithm which selects a plurality of routes between the basic modules routes a packet such that,
when two channels, i.e., channel 0 and channel 1 in rank-2,
a packet uses channel 0 at the start of a routing, the packet moves to channel 1 in a round-trip, and,
when a distance between a transmission source node and a destination node is 2^{m}/2, the packet selects an idle one of both channels in + direction and − direction, and otherwise, the destination node selects a near channel.

3. An adaptive routing for a hierarchical interconnection network using a mesh in a lower rank and a torus in a higher rank, wherein
an inter-basic-module link in the interconnection network is constituted by a ring network, and a dynamic selection algorithm of the inter-basic-module link
defines a DR number which is the number of times of movement of a packet from a sub-phase 2.p to a sub-phase 2.q (q<p) the order of which is lower than that of sub-phase 2.p for each packet, records, when a packet acquires a channel, the DR number of the channel in the channel, and routes a packet such that,
in the routing,
an adaptive routing using a channel which is not used by a packet having a DR number which is not larger than the DR number of the self-packet is performed, and,
when all the routings are blocked by packets having DR numbers which are not larger than the DR number of the self-packet, the packet moves to a deterministic routing channel without returning to the adaptive routing.
